(19) United States
(12) Patent Application Publication
(10) Pub. No.: US 2007/0224474 A1
(43) Pub. Date: Sep. 27, 2007

(54) Gas-inlet pressure adjustment structure for flow field plate of fuel cell stack

(76) Inventors: Jefferson YS Yang, Orange, CA (US); Yao-Sheng Hsu, Taipei (TW); Mike Pen-Mu Kao, Anaheim, CA (US); Feng-Hsiang Hsiao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/653,211

(22) Filed: Jan. 16, 2007

(30) Foreign Application Priority Data
Mar. 24, 2006 (TW) 95110417

(51) Int. Cl. H01M 8/04

(52) U.S. Cl. 429/25; 429/38

(57) ABSTRACT

Disclosed is a gas-inlet pressure adjustment structure for a flow field plate of a fuel cell stack. At least one gas inlet opening, at least one gas outlet opening, and a plurality of channels are defined in a central zone of the flow field plate. A membrane electrode assembly is stacked over the central zone. The channels are of a parallel arrangement and each having a reduced open end and an expanded open end, the reduced open end having a cross-sectional area smaller than that of the expanded open end. The reduced open end communicates the gas inlet opening through which a reaction gas is supplied to the flow field plate. Water generated by chemical reaction occurring inside the flow field plate and attached to a surface of the gas channel by surface tension is expelled out of the channel by a force caused by a pressure difference induced in the reaction gas, which is supplied through the gas inlet opening and flows in sequence through the reduced open end, the channel, and the expanded open end and eventually discharges through the gas outlet opening.

### FIELD OF THE INVENTION

The present invention relates to the field of fuel cell, and in particular to a gas-inlet pressure adjustment structure for a flow field plate of the fuel cell stack.

### BACKGROUND OF THE INVENTION

With the development of human civilization, the consumption of traditional energy sources such as coal, oil, and gas continuously increases, and as a consequence of the consumption of the fossil energy, environmental pollution gets more and more severe. The most significant examples of environment deterioration include temperature rise due to greenhouse effect and acidic rains. People are now well aware of the limitation of the natural resources and contributions are made to the development of new and replacement energies, among which fuel cell is one of the best potential for development and usages. Compared to the traditional internal combustion engine, the fuel cell features outstanding energy conversion efficiency, clean exhaustion gas, low noise, and the excluding of the using traditional fossil energy.

The fuel cell is an electrical generator that makes use of electro-chemical reaction between hydrogen and oxygen to generate electrical power. Generally speaking, the electro-chemical reaction carried out in the fuel cell is a reverse reaction of the electrolysis of water. Taking a proton exchange membrane fuel cell stack as an example, the fuel cell stack comprises a plurality of single cells, which will now be described with reference to FIG. 1. In FIG. 1, a cross-sectional view of a single cell of a conventional fuel cell assembly is shown, which includes a proton exchange membrane (PEM) 11 located at a central position of the single cell, two catalyst layers 12, 12a arranged on opposite sides of the proton exchange membrane 11, and two gas diffusion layers (GDLs) 13, 13a arranged on outer sides of the catalyst layers 12, 12a with an anode flow field plate 14 and a cathode flow field plate 15 arranged on the outermost sides thereof to complete the single cell 1. The anode flow field plate 14 is formed with a plurality of anode gas channels thereon, and the cathode flow field plate 15 is formed with a plurality of cathode gas channels thereon.

Also referring to FIGS. 2 and 3, wherein FIG. 2 shows a cross-sectional view of a portion of the conventional fuel cell assembly, and FIG. 3 is a cross-sectional view taken along line 3-3 of FIG. 2, a conventional fuel cell assembly, which is designated with reference numeral 100, a number of single cells 1 are stacked together with the anode flow field plate 14 of one single cell 1 and the cathode flow field plates of the next single cell 1 are combined together as a bipolar plate 16. Opposite surfaces of the bipolar plate 16 form a plurality of channels 17, serving as channels for conveying gases for the electro-chemical reaction, such as hydrogen and oxygen-contained gas, and for discharging products of the reaction, such as water droplets or moisture.

The gas flowing through the bipolar plate 16 (as well as the anode flow field plate 14 and the cathode flow field plate 15 shown in FIG. 1) must contains certain humidity in order to convey ions produced by the reaction through the proton exchange membrane 11 to effect proton exchange. When the water content carried by the gas decreases, the proton exchange membrane become dehumidified, and hence it increases the electrical resistance of the fuel cell assembly 100, reduces the voltage level, and further shortens the life span of the fuel cell assembly 100. Thus, a humidifier is often provided to ensure the gas that flows into the fuel cell assembly contains sufficient humidity.

On the other hand, heavy loading of water in the gases often results in condensation of water droplets 2 under specific conditions. The water droplets 2 may attach to the surface of the channels 17 by surface tension, and once a sufficient amount of water 2 accumulated on the surface of the channels 17, the cross-sectional area of the channels 17 that is effective for the flowing of gas is reduced or even blocked. Such a phenomenon hinders gas from flowing through the channels 17 and thus interrupts the reaction inside the fuel cell assembly 100. It will also reduce the performance of the fuel cell assembly 100. Thus, the configuration of the channels 17 of the bipolar plate 16 (as well as the anode flow field plate and cathode flow field plate) is important for the fuel cell assembly 100.

If the channels 17 are blocked by the condensed water 2 and the pressures at the inlet end and the outlet end of the channels 17 are substantially the same or close to each other, a force acting on the water 2, which is the product of the pressure difference ΔP₁ between the inlet end and the outlet end of the channels 17 and the cross-sectional area of the channels 17, is insufficient to overcome the viscous force and surface tension of the water 2. As a result, water 2 maintains inside the channels 17. To eliminate the accumulation of water 2 in the channels 17 one the most commonly measures is to simply increase the pressure at the inlet end of the channels 17, which in turn increases the product of the pressure difference ΔP₁ and the cross-sectional area, to such an extent sufficient to blow the water out of the channel 17.

However, practical experience shows that when the pressure difference ΔP₁ is great enough to generate sufficient force to drive the water out of the channels, the pressure at the inlet end of the channels 17 is often very high. This high pressure will cause the displacement or peeling of the proton exchange membrane, the catalyst layers, and the gas diffusion layers, or even the breaking or the damaging of the proton exchange membrane, the catalyst layers, and the gas diffusion layers.

Thus, the conventional fuel cell must be timely humidified in order to maintain the motivity of reaction ions and to prevent the proton exchange membrane from dehumidification. However, on the other hand, the conventional fuel cell suffers from blocking by condensed water that negatively affects the operation of the fuel cell assembly. The incorporation of a pressure boosting device, such as a blower, to increase the pressure inside the channels for removing the condensed water out of the channel would adversely cause displacement, stripping and damage of the proton exchange membrane, the catalyst layers, and the gas diffusion layers.

Thus, the present invention is aimed to provide a gas-inlet pressure adjustment structure for a flow field plate of a fuel cell, which has a reduced cross-sectional area at an inlet end of the channels to reduce the contact area between the proton exchange membrane and the channels so as to reduce the surface area of the proton exchange membrane, to which outward driving forces are induced by the high pressure gases in the channels.

### SUMMARY OF THE INVENTION

To solve the problem encountered in the conventional fuel cell assembly, the present invention provides a gas-inlet pressure adjustment structure for a flow field plate of a fuel cell, wherein the flow field plate is constructed in a fuel cell and is covered with a proton exchange membrane. The flow field plate includes at least one gas inlet opening, one gas outlet opening, and a plurality of channels. The channels are of a parallel arrangement and each has a reduced open end and an expanded open end. The reduced open end has a cross-sectional area smaller than that of the expanded open end. The reduced open end communicates with the gas inlet opening, while the expanded open end communicates with the gas outlet opening.

Water droplets are generated inside the channels when the chemical reaction is carried out in the fuel cell. The water attaches to the surface of the channels by the surface tension. A pressure boosting device, such as a blower, is employed to increase the pressure at the gas inlet opening to such an extent that the pressure difference between ends of the channels is sufficient to drive the water out of the channels through the gas outlet opening.

Further, since the cross-sectional area at the reduced open end is small, which makes the contact area between the proton exchange membrane and the reduced open end of the channel small and thus reduces the outward driving force induced by the gas pressure inside the channel, it is less likely for the proton exchange membrane, the catalyst layers, and the gas diffusion layers to displace, peel, break or damage.

In comparison with conventional technologies, the gas-inlet pressure adjustment structure of the flow field plate of the fuel cell in accordance with the present invention can effectively remove the water condensed in the gas channel thereof and also reduces the outward driving force acting on the proton exchange membrane induced by the pressure to thereby protect the proton exchange membrane from displacing, peeling, breaking and otherwise damaging.

### BRIEF DESCRIPTION OF THE DRAWINGS

The present invention will be apparent to those skilled in the art by reading the following description of preferred embodiments thereof, with reference to the attached drawings, in which:

FIG. 1 schematically shows a cross-section of a single cell of a conventional fuel cell assembly;

FIG. 2 shows a cross-sectional view of a portion of the conventional fuel cell assembly;

FIG. 3 shows a cross-sectional view taken along line 3-3 of FIG. 2;

FIG. 4 shows a plan view of a flow field plate for a fuel cell in accordance with a first embodiment of the present invention;

FIG. 5 shows an enlarged view of encircled portion A in FIG. 4;

FIG. 6 shows a cross-sectional view taken along line 6-6 of FIG. 5;

FIG. 7 shows a cross-sectional view taken along line 7-7 of FIG. 5;

FIG. 8 shows relative positions between portions of the flow field plate of the first embodiment of the present invention and a membrane electrode assembly;

FIG. 9 shows a cross-sectional view illustrating that adjacent flow field plates of the present invention are sealed with a sealing element;

FIG. 10 schematically shows the channels of the flow field plate of the present invention to illustrate expulsion of condensed water from the channels by pressure difference;

FIG. 11 schematically shows a flow field plate constructed in accordance with a second embodiment of the present invention; and

FIG. 12 schematically shows a flow field plate constructed in accordance with a third embodiment of the present invention.

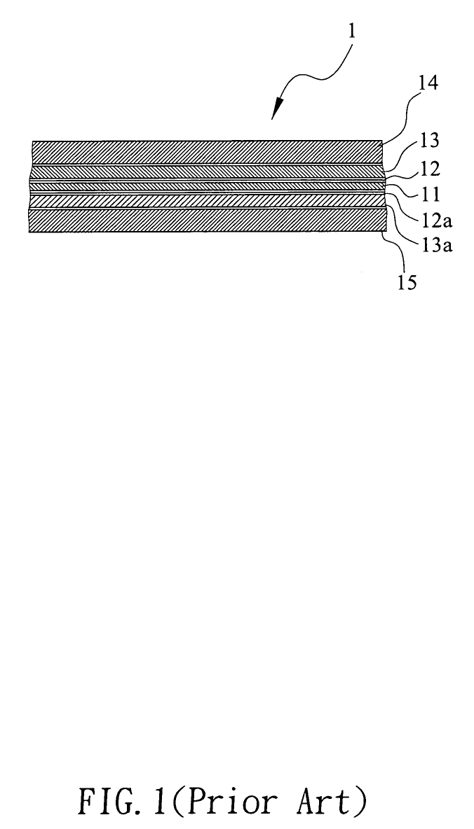

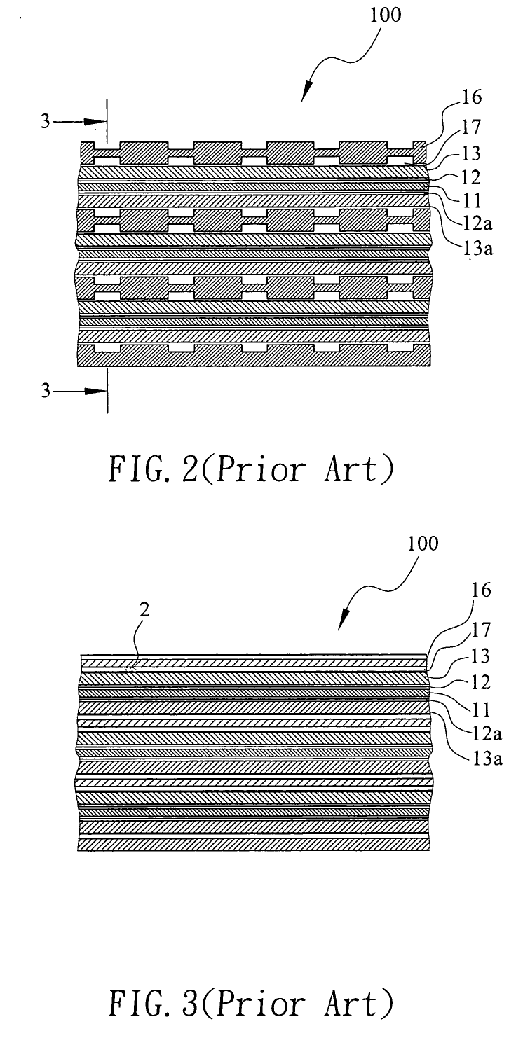

### DETAILED DESCRIPTION OF THE PREFERRED EMBODIMENTS

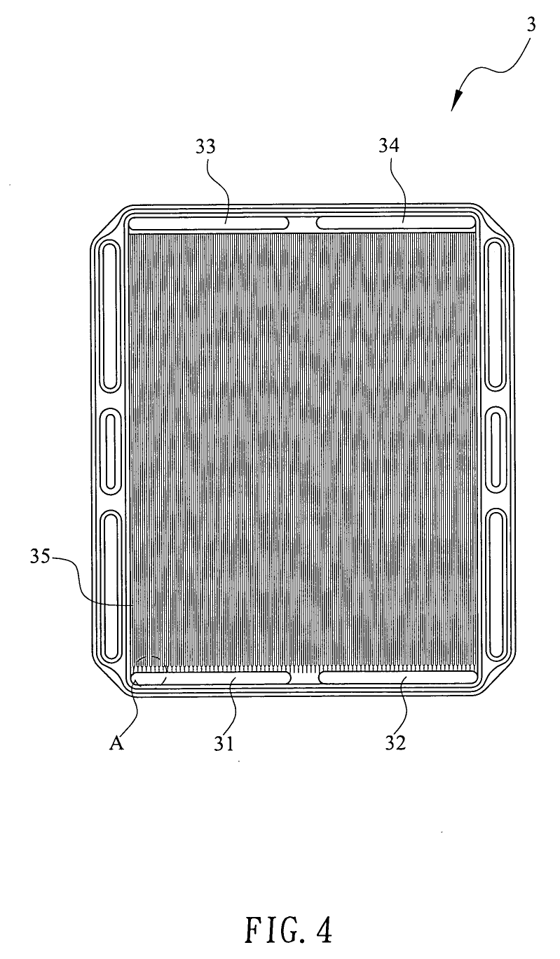

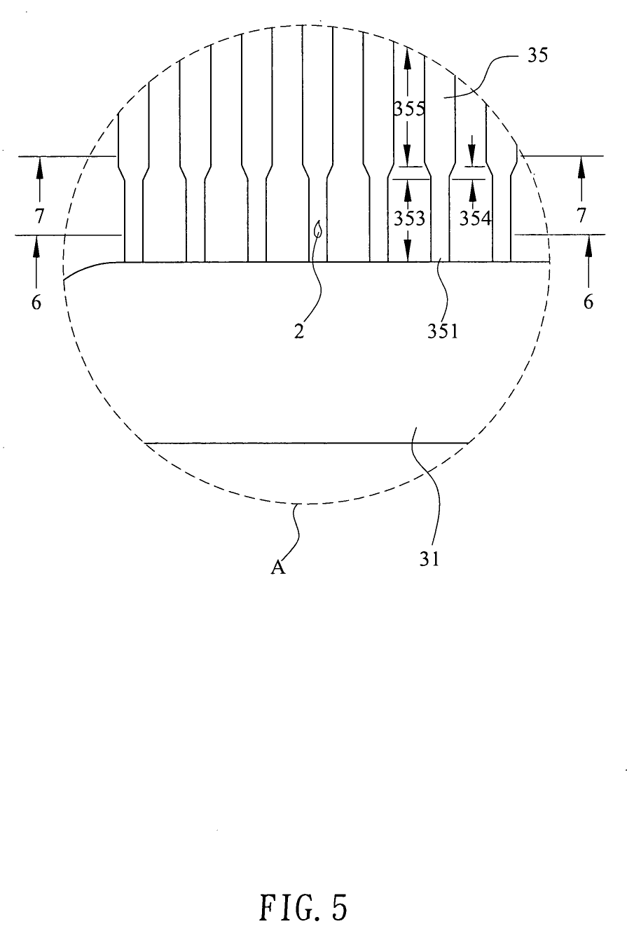

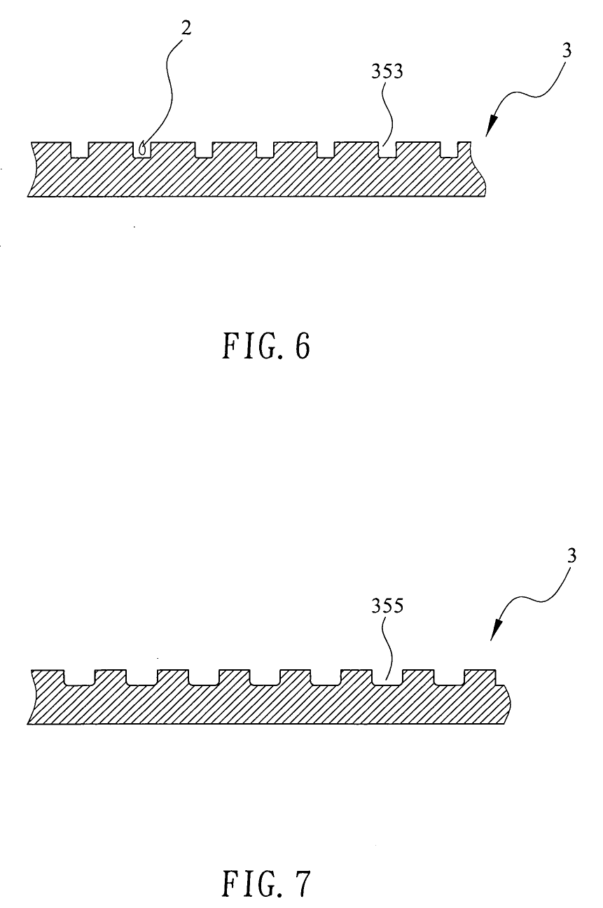

With reference to the drawings and in particular to FIGS. 4 to 8, a flow field plate, which constitutes in part a fuel cell stack, constructed in accordance with the present invention, generally designated with reference numeral 3, comprises two gas inlet openings 31, 32, two gas outlet openings 33, 34, and a plurality of channels 35. A membrane electrode assembly 4 and another flow field plate 3′ are sequentially stacked over the flow field plate 3. The flow field plate 3 forms a circumferentially extending groove 36 surrounding a central zone of the flow field plate 3 in a surface opposing the flow field plate 3′ and similarly, the flow field plate 3′ forms a counterpart groove facing the flow field plate 3.

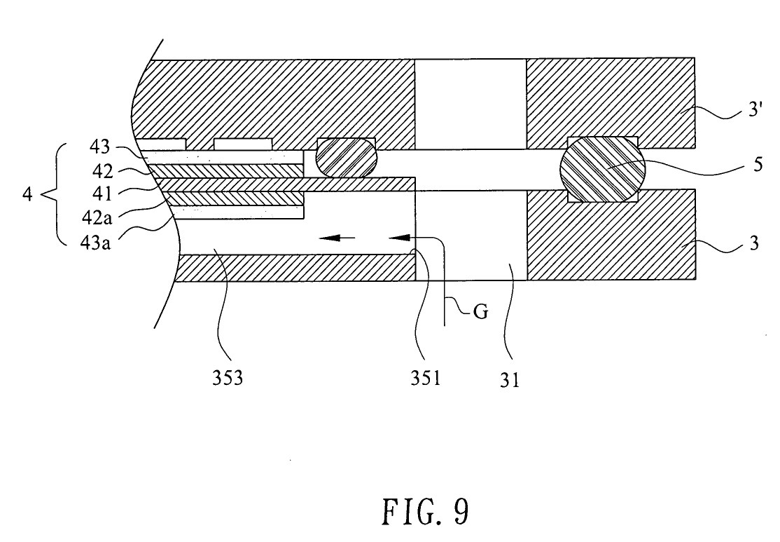

A sealing element 5 (as shown in FIG. 9, the sealing element 5 comprises a loop-like thermoplastic member in the embodiment illustrated) is received in the grooves 36 and retained between the flow field plates 3, 3′ to tightly enclose the gas inlet openings 31, 32, the gas outlet openings 33, 34, the channels 35, and the membrane electrode assembly 4 between the flow field plates 3, 3′ with open top sides of the channels 35 in contact with the membrane electrode assembly 4.

The membrane electrode assembly 4 comprises a proton exchange membrane 41, two catalyst layers 42, 42a, and two gas diffusion layers 43, 43a.

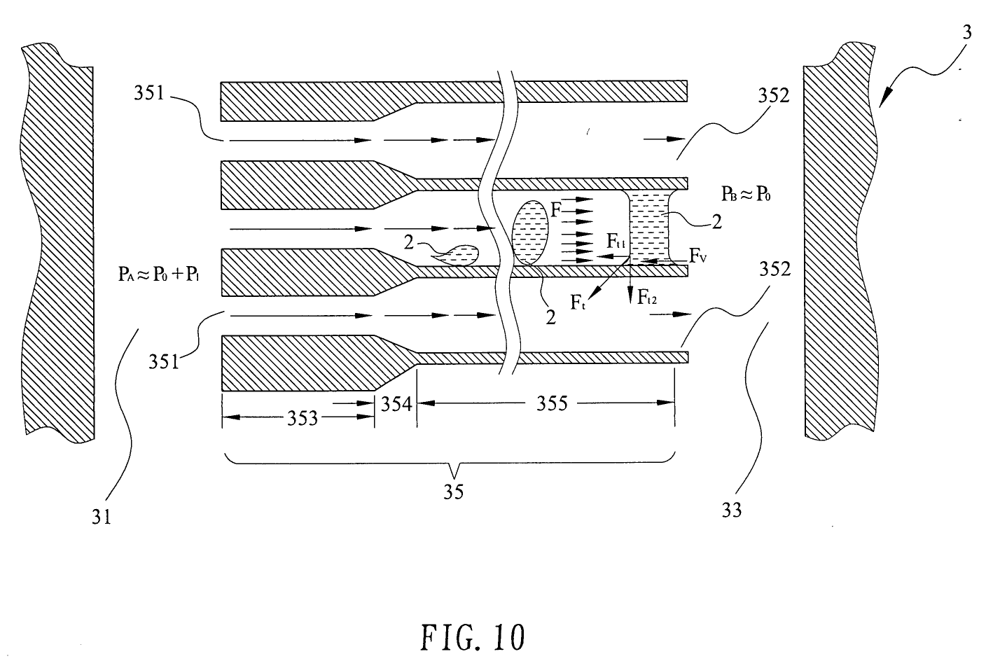

Also referring to FIG. 10, the channels 35 are formed on the flow field plate 3 in a parallel arrangement and have a reduced open end 351 and an expanded open end 352. The reduced open end 351 has a cross-sectional area smaller than that of the expanded open end 352. The reduced open ends 351 are in communication with the gas inlet opening 31, while the expanded open ends 352 are in communication with the gas outlet opening 33.

Each channel 35 is comprised of a narrow channel section 353, a divergent channel section 354, and a wide channel section 355. The narrow channel section 353 communicates with the gas inlet opening 31 via the reduced open end 351. The divergent channel section 354 is extended and communicates between the narrow channel section 353 and the wide channel section 355 with cross-sectional area thereof increased from where the divergent channel section 354 connects to the narrow channel section 353 to where the divergent channel section 354 connects to the wide channel section 355. The wide channel section 355 communicates with the gas outlet opening 33 via the expanded open end 352.

When gas reaction occurs inside the fuel cell, a reaction gas G, which can be hydrogen or a gas containing oxygen, enters the flow field plate 3 via the gas inlet opening 31, flowing in sequence through the narrow channel section 353, the divergent channel section 354, and the wide channel section 355 to carry out gas reaction. After the reaction, reacted gas flows out of the flow field plate 3 via the gas outlet opening 33.

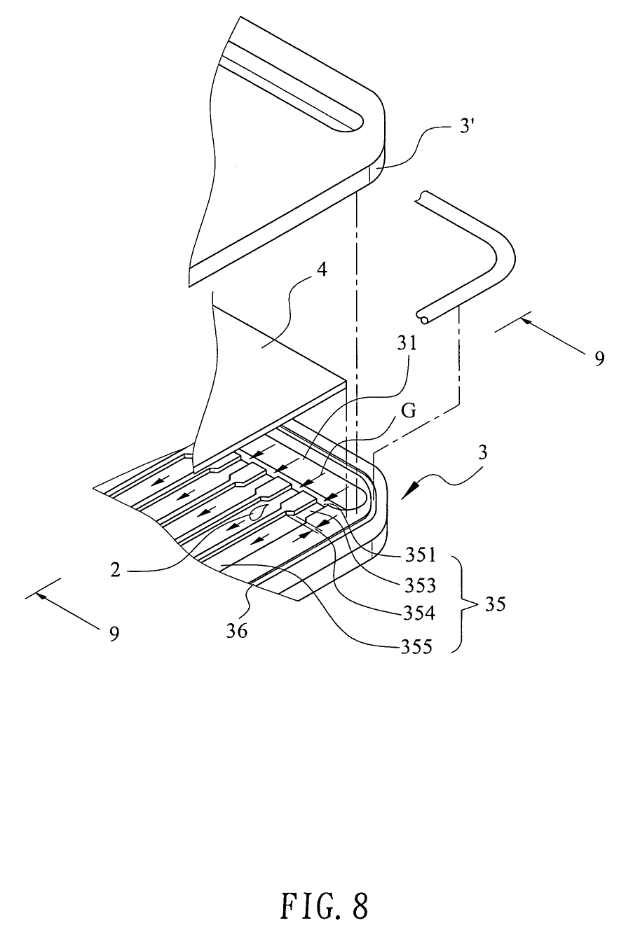

As shown in FIG. 8, after the gas reaction, water 2 formed may condense on the surface of the channel 35 and attaches to the surface of the channel 35 due to attraction induced by surface tension, and gradually blocks the channel 35. At this moment, a pressure boosting device, such as a blower, can be employed to increase the pressure of the reaction gas in the gas inlet opening 31, whereby the pressure of the reaction gas in the gas inlet opening 31 gets greater than the pressure in the gas outlet opening 33. Such a pressure difference suffices to force the reaction gas to expel the condensed water 2 out of the gas channel 35 through the gas outlet opening 33. Further, since the top open side of the channel 35 is in direct contact with the membrane electrode assembly 4, the pressure difference also causes force acting upon the membrane electrode assembly 4.

To further explain, referring to FIG. 10, assuming, without losing generality, that the pressure of the gas inlet opening 31 is P_{A}, which is approximately equal to the boosting pressure P₁ provided by the pressure boosting device, plus surrounding pressure, which is approximately one atmosphere, P₀. The pressure P_{B} of the gas outlet opening 33 corresponds to the surrounding pressure, that is approximately one atmosphere, P₀.

The resultant force F is thus the multiplication of the pressure difference ΔP₂, approximately equal to subtraction of P_{B} from P_{A}, by the cross-sectional area A of the channel. In other words, F=ΔP₂×A. When the channel 35 is blocked by the condensed water 2, a viscous force Fᵥ and a surface tension F₁ are present between the water 2 and the surface of the channel 35. The surface tension F₁ can be resolved into a horizontal component Fₜ₁ and a vertical component Fₜ₂. Based on Newton's laws of force, when the resultant force F caused by pressure difference is greater than the sum of the viscous force Fᵥ and the horizontal component Fₜ₁ of the surface tension Fₜ, namely F>Fᵥ+Fₜ₁, the condensed water 2 will be forced toward the gas outlet opening 33 and is eventually expelled out of the channel 35.

It is apparent to those having ordinary skills in the art that the flow field plate 3 can be an anode flow field plate or a cathode flow field plate or a bipolar plate. Further, the gas inlet opening 31 can be an inlet for hydrogen or an oxygen-contained gas that is required for the reaction of the fuel cell stack. In addition, the reduced open end 351 of the channel 35 has a small cross-sectional area and thus forms a small contact area with the membrane electrode assembly 4 so that the outward driving force acting on the membrane electrode assembly 4 by the pressure inside the channel 35 is reduced and thus breaking, damaging and/or peeling of the catalyst layers 42, 42a, and gas diffusion layers 43, 43a of the membrane electrode assembly 4 caused by the outward driving force is less likely to happen.

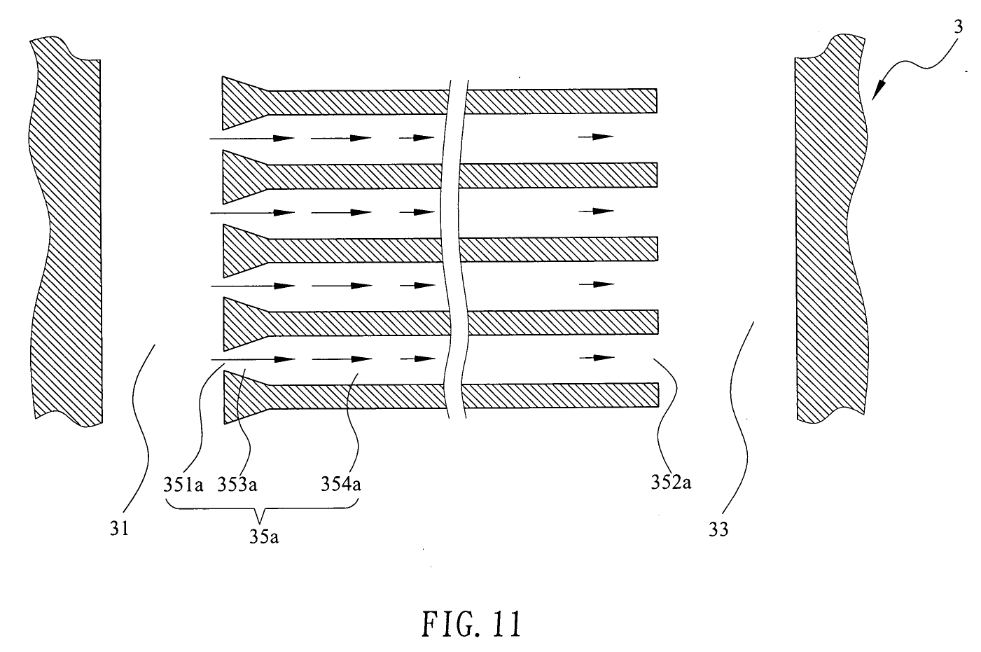

Referring to FIG. 11, which schematically shows a flow field plate constructed in accordance with a second embodiment of the present invention, a major difference between the second embodiment illustrated in FIG. 11 and that of first embodiment illustrated in FIG. 10 resides in a modified channel 35a, which replaces the channel 35 of the embodiment shown in FIG. 10. The channel 35a has a reduced open end 351a and an expanded open end 352a and the reduced open end 351a has a cross-sectional area smaller than that of the expanded open end 352a.

The reduced open end 351a communicates with the gas inlet opening 31, while the expanded open end 352 communicates with the gas outlet opening 33. The channel 35a is composed of a divergent channel section 353a and a wide channel section 354a. The divergent channel section 353a is extended from the reduced open end 351a to the wide channel section 354a and communicates with the gas inlet openings 31 via the reduced open end 351a. The wide channel section 354a communicates with the gas outlet opening 33 via the expanded open end 352a.

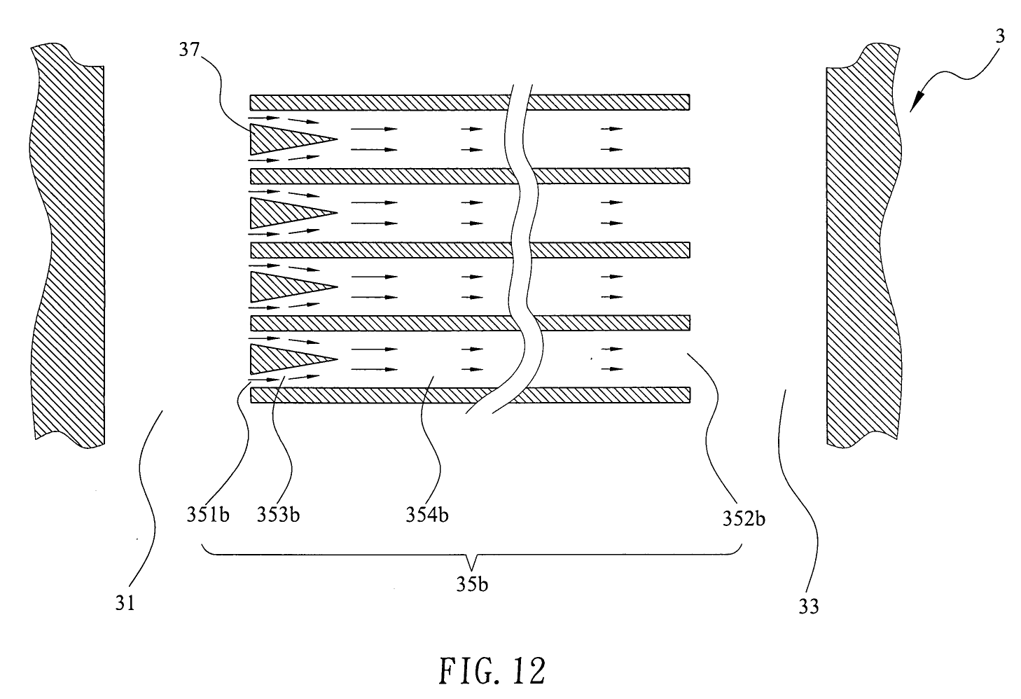

Referring to FIG. 12, which shows a flow field plate constructed in accordance with a third embodiment of the present invention, a major difference between the third embodiment illustrated in FIG. 12 and the first embodiment illustrated in FIG. 10 resides in a modified channel 35b, which replaces the channel 35 of the embodiment shown in FIG. 10. The channel 35b has an end in communication with the gas inlet opening 31 and an opposite end in communication with the gas outlet opening 33.

An inverted triangular flow division wedge 37 is arranged in the end of the channel 35b that communicates with the gas inlet opening 31 to make the end a reduced open end 351b. The opposite end of the channel 35b that communicates with the gas outlet opening 33 thus serves as an expanded open end 352b of the channel 35b. Thus, the reduced open end 351b has a cross-sectional area smaller than that of the expanded open end 352b. The channel 35b is thus composed of a divergent channel section 353b, which is the portion of the channel 35b that accommodates the flow division wedge 37, and a wide channel section 354b. The divergent channel section 353b is extended from the reduced open end 351b to the wide channel section 354b and communicates with the gas inlet openings 31 via the reduced open end 351b. The wide channel section 354b communicates with the gas outlet opening 33 via the expanded open end 352b.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A gas-inlet pressure adjustment structure for a flow field plate having a central zone and a membrane electrode assembly stacked over the central zone of a fuel cell stack, comprising:
at least one gas inlet opening for supplying a reaction gas to the flow field plate;
at least one gas outlet opening for discharging gas from the flow field plate; and
a plurality of channels in a parallel arrangement and each having a reduced open end for communicating the gas inlet opening and an expanded open end for communicating the gas outlet opening, with the reduced open end having a cross-sectional area smaller than a cross-sectional area of the expanded open end,
wherein at least one water drop occurring inside the flow field plate and attached to a surface of the gas channel is expelled out of the channel by a force caused by a pressure difference induced in the reaction gas, which is supplied through the gas inlet opening and flows in sequence through the reduced open end, the gas channel, and the expanded open end and eventually discharges through the gas outlet opening.

2. The gas-inlet pressure adjustment structure as claimed in claim 1, wherein the channel further comprises a narrow channel section for communicating with the gas inlet opening via the reduced open end, a wide channel section for communicating the gas outlet opening via the expanded open end, and a divergent channel section for connecting the narrow channel section and the wide channel section.

3. The gas-inlet pressure adjustment structure as claimed in claim 1, wherein the channel further comprises a wide channel section for communicating the gas outlet opening via the expanded open end and a divergent channel section for communicating with the gas inlet opening via the reduced open end and connecting to the wide channel section.

4. The gas-inlet pressure adjustment structure as claimed in claim 1, wherein the flow field plate is an anode flow field plate of the fuel cell stack.

5. The gas-inlet pressure adjustment structure as claimed in claim 1, wherein the flow field plate is a cathode flow field plate of the fuel cell stack.

6. The gas-inlet pressure adjustment structure as claimed in claim 1, wherein the flow field plate is a bipolar plate of the fuel cell stack.

7. The gas-inlet pressure adjustment structure as claimed in claim 1, wherein the gas inlet opening serves as an inlet of hydrogen and the gas outlet opening serves as an outlet of hydrogen.

8. The gas-inlet pressure adjustment structure as claimed in claim 1, wherein the gas inlet opening serves as an inlet of an oxygen-contained gas and the gas outlet opening serves as an outlet of the oxygen-contained gas.
